(19) United States
(12) Patent Application Publication
(10) Pub. No.: US 2024/0066835 A1
(43) Pub. Date: Feb. 29, 2024

(54) LIGHTNING STRIKE PROTECTION MATERIAL AND STRUCTURE

(71) Applicant: LUXEMBOURG INSTITUTE OF SCIENCE AND TECHNOLOGY (LIST), ESCH-SUR ALZETTE (LU)

(72) Inventors: Antoine DUHAIN, ESCH-SUR ALZETTE (LU); Guillaume LAMBLIN, ESCH-SUR ALZETTE (LU); Damien LENOBLE, ESCH-SUR ALZETTE (LU); Marc MICHEL, ESCH-SUR ALZETTE (LU)

(21) Appl. No.: 18/269,829

(22) PCT Filed: Dec. 24, 2021
(86) PCT No.: PCT/EP2021/087642

§ 371 Date: Jun. 27, 2023

(30) Foreign Application Priority Data
Dec. 31, 2020 (LU) 102368

(51) Int. Cl. B32B 9/04; B32B 5/02; B32B 9/00; B32B 15/02; B32B 15/04; B32B 15/14; B32B 15/20; B64D 45/02

(52) U.S. Cl. CPC B32B 9/041; B32B 5/02; B32B 9/007; B32B 15/02; B32B 15/043; B32B 15/14; B32B 15/20; B64D 45/02; B32B 2262/106; B32B 2307/202; B32B 2307/7376; B32B 2605/18

(57) ABSTRACT

A lightning strike protection material is proposed that includes a substrate, the substrate carrying a metal layer, and, on the metal layer, a copper-nanocarbon composite layer, the copper-nanocarbon composite layer having a nanocarbon tangle formed of carbon nanotubes and/or graphene sheets, the nanocarbon tangle embedded within a copper phase and distributed throughout the copper-nanocarbon composite layer.

### TECHNICAL FIELD

The disclosure generally relates to a lightning strike protection material, in particular a lightning strike protection material comprising a metal-nanocarbon composite material.

### BACKGROUND

Composite materials, e.g., carbon fiber reinforced polymers (CFRPs), are increasingly used by various industries, e.g., the aircraft and aerospace industry, manufacturers of wind turbines, gas storage tanks, automobiles, or other vehicles, etc., replacing aluminum and other metals in certain applications. Composite materials provide equal or improved structural performance, material strength and stiffness, while reducing aircraft weight. CFRPs comprise carbon fiber reinforcements embedded in a matrix, usually a polymer resin (e.g., epoxy, polyester, nylon, etc.), binding the reinforcements together.

One drawback of this development is that aircraft hulls (fuselage, wings, tail) or structural materials in other areas of technology that include a high amount of composite materials need additional protection against lightning strikes. Indeed, composite materials are less conductive than metal and thus provide less intrinsic protection against lightning strikes.

Therefore, systems and materials have been developed to provide lightning strike protection for composite structures such as, e.g., aircraft skins and/or structures. As reported by Kumar, Yadav Khagendra. (2018), “Aircraft and Lightning strike”, 10.13140/RG.2.2.17145.52326, the Boeing 787 and the Airbus A350 feature more than 50% of composite materials (by weight). Both manufacturers have adopted a solution of LSP (lightning strike protection) on their aircrafts (wire mesh laminated into composite elements on the Boeing 787, metallic foils embedded into composite structural parts on the Airbus A350).

US 2012/145319 A1 reports that metallic conductors or metal foil systems of various configurations may be integrated into composite exterior surfaces of the aircraft to provide improved electrical conductivity and distribute and divert current away from flight critical areas and underlying aircraft components. Applique-based systems that use alternate layers of dielectric and conductive materials applied over the composite structure surface and secured to the surface with an adhesive insulate underlying aircraft components from a lightning strike and provide a conductive path for rapid distribution and dissipation of lightning current and heat. US 2012/145319 A1 criticizes, however, that such systems often involve manual, tedious, and time consuming placement of multiple material components necessary for effective integration of the lightning strike protection system and proposes an integrated lightning strike protection system adapted for automated placement on a composite structure having a surfacing layer consisting of an organic polymer resin, a conductive layer of an expanded metal foil, an isolation/tack layer, and a carrier paper layer. In another embodiment of the disclosure of US 2012/145319 A1, there is provided an integrated lightning strike protection system having an integrated lightning strike protection material consisting of an expanded metal foil encapsulated in organic polymer resin mounted on a carrier paper, and an automated placement machine suitable for placing the material on an aircraft composite part for protection of the composite part from lightning strikes.

US 2004/246651 A1 discloses a lightning strike protection system for aircraft fuel tanks made of low electrical conductivity composite material. The system comprises an electrical conductive thin wire mesh that covers the whole external surface of the tank outer skin made of composite and a thick wire metallic mesh overlapping the mesh at a minimum distance of 50 mm to both sides of a row of fasteners joining the said outer skin to one internal part of either composite or metallic material. Both metallic meshes maintain electrical contact by their installation/assembly and by means of metallic countersunk head washers connected to bonding points and set to the gap existing between the fastener and the outer skin.

US 2013/105190 A1 relates to a multilayer lightning strike protection material. The multilayer lightning strike protection material is configured adjoinable, at least partially, to an object to be protected and comprises a dielectric layer and an electrically conductive layer, wherein the material comprises a second dielectric layer, the conductive layer being interposed between the dielectric layers and thickness d of at least one dielectric layer is not less than 0.1 mm.

US 2016/340518 A1 discloses lightning strike protective compositions. A composition for providing protection against electrical discharges (e.g., including lightning strikes) for composite structures includes a binder material capable of dispersing material structures therein and attaching to a surface of a substrate, and a plurality of pigment structures dispersed in the binder material. The pigment structures include a central layer including an electrically conducting material, and outer layers formed on the central layer, in which the outer layers include an optical absorber material or a dielectric material. The composition, when attached to the substrate, provides electrically conductive paths to transfer electrical current from a multi kiloamp electrical discharge.

### BRIEF SUMMARY

The present disclosure proposes a lightning strike protection material based on a metal-nanocarbon composite material.

According to a first aspect of the disclosure, a lightning strike protection material comprises a substrate (e.g. a carbon fiber reinforced polymer), the substrate carrying a metal layer (preferably a copper or aluminium layer), and, on the metal layer, a copper-nanocarbon composite layer, the copper-nanocarbon composite layer, comprising a nanocarbon tangle comprised of carbon nanotubes (CNTs) and/or graphene sheets, the nanocarbon tangle embedded within a copper phase and distributed throughout the copper-nanocarbon composite layer.

The expression “nanocarbon tangle” herein designates a three-dimensional cluster of CNTs and/or graphene sheets (also: flakes) in generally disordered arrangement. Preferably, the CNTs and/or graphene sheets of the tangle are randomly oriented, such that the nanocarbon tangle resembles a thicket, but it should be noted that perfect randomness of the orientations of the CNTs and/or graphene sheets (implying isotropy) is not a requirement. CNTs could be single-walled and/or multiwalled CNTs. The term “graphene sheets” used herein is intended to cover graphene monolayers, bilayers, or multilayers in various configurations, e.g., flat, twisted, rolled, stripes, ribbons, etc.

In the context of the present disclosure, the expression “metal layer” is intended to designate an essentially metallic layer. The metal layer could be made of copper, with the proviso that it does not contain a nanocarbon tangle or other significant amounts of nanocarbon (impurities being possible) and, therefore, does not qualify as copper-nanocarbon composite layer. The copper of the copper phase of the copper-nanocarbon composite layer and, if the metal layer is or includes a copper layer, the copper of the metal layer is preferably electrolytic-tough pitch (ETP) copper (CW004A or ASTM designation C11040).

The CNTs and/or graphene sheets used in the context of the proposed method preferably comprise hydrophilic coatings. The nanocarbon tangle could initially be provided in the form of a nanocarbon tissue (packaged in dry form or in a liquid medium). Alternatively, hydrophilization of the CNTs and/or graphene sheets could be part of the process. The hydrophilic coating preferably comprises polyphenol or poly(catecholamine). More preferably, the hydrophilic coating comprises metal ions that crosslink the polyphenol or the poly(catecholamine) and/or that are chelated by the polyphenol or the poly(catecholamine). Examples of polyphenol and poly(catecholamine) are tannic acid and polydopamine, respectively. Polyphenol and poly(catecholamine) are hydrophilic and have redox activity (i.e., are capable of reducing metal ions). Specifically, they are capable of chelating and/or crosslinking with metal ions. Another property that makes these substances interesting in the present context is their ability to coat CNTs or graphene due to π−π interaction.

If hydrophilization of the CNTs and/or the graphene is part of the process, coating of the CNTs and/or the graphene is preferably carried out in a solution containing phenol and/or catecholamine moieties wherein initially uncoated CNTs and/or graphene sheets are dispersed. Preferably, the solution also contains a certain amount of metal ions capable of crosslinking the phenol and/or catecholamine moieties and/or of forming chelates with them. The coating of the CNT and/or graphene may be carried out under sonication, e.g., under ultra-sonication, and/or under stirring. The solution may further comprise one or more catalysts, buffering agents, etc. The CNTs and/or graphene sheets are preferably oxidized prior to dispersion in the solution containing the phenol and/or catecholamine moieties.

The copper-nanocarbon composite layer is preferably fabricated as disclosed in WO 2020/043590 A1, incorporated herein by reference in its entirety. In this context, it is worthwhile noting that the CNTs used in that disclosure may be replaced partially or in full by graphene sheets when implementing the methods of that disclosure.

It will be appreciated that the lightning strike protection material may be an integral part of the structure to be protected (e.g., aircraft skin, wind turbine blade materials, gas tank skins, etc.), or be applied on such structure. It will be appreciated that the present disclosure may be used to produce more lightweight lightning strike protection materials, which offer the same if not a better level of protection.

The copper-nanocarbon composite layer preferably serves as sacrificial protection layer, susceptible of being locally destroyed upon being hit by lightning. It has been discovered that, when lightning hits the proposed assembly of a copper-nanocarbon composite layer on a metal layer, a hole may form in the copper-nanocarbon composite layer while the metal layer remains intact. This is an interesting property of the proposed material because even after a lightning strike, a continuous conductive layer has a higher likelihood to subsist and thus to protect, to some extent, the underlying structure. Experiments conducted with the proposed assembly of a copper-nanocarbon composite layer on a copper layer and, for comparison, with an assembly of two copper layers have shown that complete perforations are more likely to occur with an assembly of two copper layers.

In the lightning strike protection material, the metal layer preferably has a thickness in the range from 0.5 μm to 50 μm. Additionally, or alternatively, the copper-nanocarbon composite layer may have a thickness in the range from 0.5 μm to 50 μm.

The metal layer and/or the copper-nanocarbon composite layer could comprise (or consist of) a plain (unpatterned) layer or a mesh layer (e.g., a hexagonal or quadrangular mesh). In particular, one of the metal layer and the copper-nanocarbon composite layer could be a plain layer whereas the other one of the metal layer and the copper-nanocarbon composite layer is a mesh layer.

To save weight, each one of the metal layer and the copper-nanocarbon composite layer could be a mesh layer.

The lightning strike protection material may further comprise a nickel interface (e.g., a few nanometers thick) between the metal layer and the copper-nanocarbon composite layer.

Preferably, the copper-nanocarbon composite layer comprises at least 10% by volume of carbon nanotubes and/or graphene sheets. The volume percentage of nanocarbon in the copper-nanocarbon composite layer can be calculated by:

$$nano C vol . \% = \frac{{V}_{nano C}}{{V}_{composite}} \cdot 100 = \frac{{V}_{composite} - {V}_{metal}}{{V}_{composite}} \cdot 100 \qquad ( Eq . 1 )$$

$${V}_{metal} = \frac{{m}_{metal}}{{γ}_{metal}} = \frac{{m}_{composite - {m}_{nano C}}}{{γ}_{metal}} \qquad ( Eq . 2 )$$

where:
V_{composite} is the measured volume of the composite (e.g., in cm³),
Vₘₑₜₐₗ, obtained by Eq. 2, is the volume of the metal contained in the composite,
m_{composite} is the measured mass of the composite (e.g., in g),
m_{nano C} is the measured mass of the (dry) nanocarbon tangle before electrodeposition (e.g., in g),
γₘₑₜₐₗ is the specific mass of the metal (e.g., in g/cm³).

In the present document, the verb “to comprise” and the expression “comprised of” are used as open transitional phrases meaning “consist at least of” or “include”. Unless otherwise implied by context, the use of singular word form is intended to encompass the plural, except when the cardinal number “one” is used: “one” herein means “exactly one”.

### BRIEF DESCRIPTION OF THE DRAWINGS

By way of example, preferred, non-limiting embodiments of the disclosure will now be described in detail with reference to the accompanying drawings, in which:

FIG. 1: is an illustration of a modelized lightning current waveform, used in the literature to evaluate the direct effects of a lightning strike;

FIG. 2: is a schematic cross-sectional view of a lightning strike protection material according to a preferred embodiment of the disclosure;

FIG. 3: is a schematic of the lightning strike protection material of FIG. 2 after a lightning strike;

FIG. 4: shows photographs of an inventive lightning strike protection material sample before (top photograph) and after (bottom photograph) being hit by a lightning strike;

FIG. 5: shows photographs of a comparative sample before and after being hit by a lightning strike.

### DETAILED DESCRIPTION

According to SAE Aerospace Recommended Practice (ARP) 5414, Aircraft lightning zoning, SAE Int., 1999, one can define different lightning strike zones on the exterior surface of a typical large aircraft, in accordance with the various types of lightning currents that these zones are most likely to experience. A detailed description of the zones can be found in the above-mentioned report by Kumar. Zone 1 regions (subdivided into zones 1A, 1B and 10) correspond to the areas that are likely to experience initial lightning attachment and first return strokes. Zones 1 include typically the aircraft nose and the wing tips. Zone 2 regions (zones 2A and 2B), including the majority of the hull, are those likely to experience subsequent swept strokes, or re-strikes. Zone 3 corresponds to strike locations other than zones 1 and 2, where attachment of the lightning channel is unlikely.

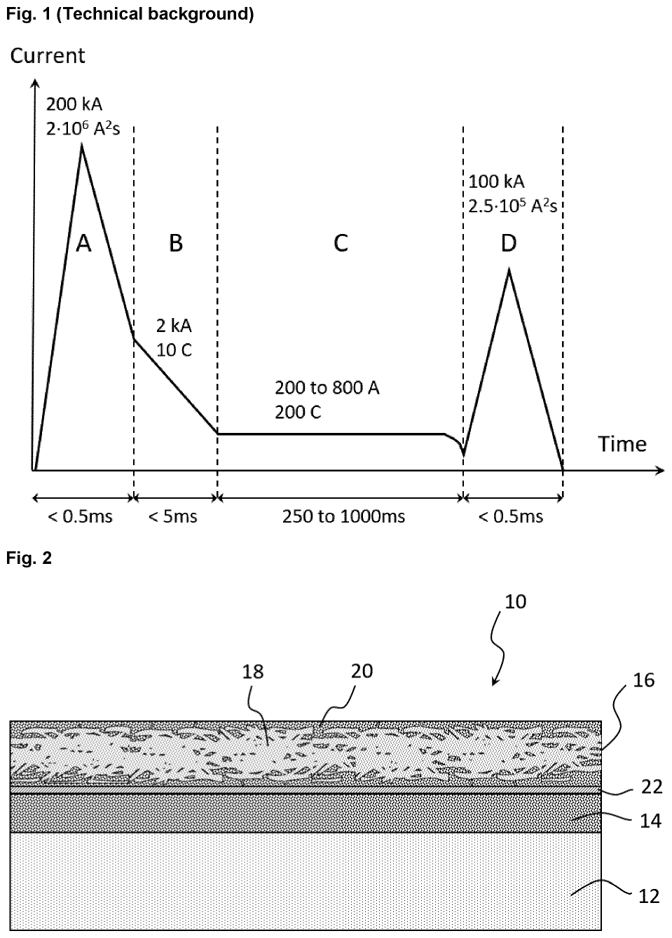

FIG. 1 illustrates a modelized lightning current waveform, used in the literature to evaluate the direct effects of a lightning strike. It should be noted that the diagram is schematic and not to scale along either axis. The initial return stroke is shown in portion “A” and has a peak amplitude around 200 kA, an action integral around 2·10⁶ A² s and a duration ≤500 μs. Current component “B” is the “intermediate current” with an average amplitude of about 2 kA, a charge transfer of about 10 C a duration ≤5 ms. Component “C” is a continuing current with an amplitude typically between 200 and 800 A, a charge transfer of about 200 C and a time duration typically between 0.25 s and 1 s. Finally, current component “D” (also: “D wave”) is a subsequent stroke with a typical peak amplitude around 100 kA, an action integral around 0.25·10⁶ A²s and a time duration ≤500 μs. The initial stroke A occurs primarily in zone 1 and lightning strike protection in this zone has to be configured accordingly. Lightning strike protection in zone 2 must be able to withstand D waves. Both zones 1 and 2 further have to sustain currents B and C.

Conventional lightning strike protection materials are mainly based on copper: copper meshes are heat pressed against or into the composites fiber substrates to provide them with electrical conductivity. The weight of copper is, however, high and there is still a need of good electrical conductors with low specific conductivity and high ampacity. A reduction by 50% of the weight of the copper meshes would, for example, allow saving 100 to 200 kg per aircraft. Also, the ampacity of copper is limited compared to carbon-based materials.

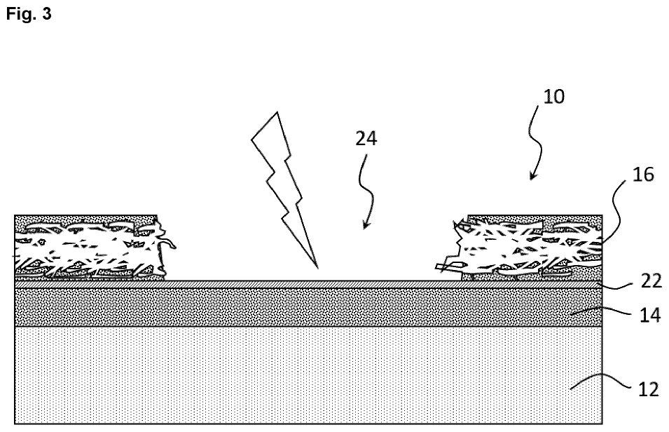

FIGS. 2 and 3 show schematic cross-sectional views of a lightning strike protection (LSP) material 10 according to a preferred embodiment of the disclosure. The LSP material comprises a substrate 12 (e.g., a CR4-type epoxy resist), which carries a metal layer 14, and, on the metal layer 14, a copper-nanocarbon composite layer 16. The copper-nanocarbon composite layer 16 is comprised of a nanocarbon tissue 18 and a copper phase 20 (or copper matrix), wherein the nanocarbon tissue 18 is embedded. The nanocarbon tissue 18 is comprised of CNTs and/or graphene sheets, preferably polydopamine-coated CNTs and/or polydopamine-coated graphene sheets. The metal layer 14 preferably has a thickness in the range from 0.5 μm to 50 μm, e.g., 3 μm. The copper-nanocarbon composite layer 16 may have a thickness in the range from 0.5 μm to 50 μm, e.g., 12 μm to 20 μm, e.g., 15 μm. The metal layer 14 and/or the copper-nanocarbon composite layer 16 could be plain or mesh layers, one independent of the other. In particular, one of the metal layer 14 and the copper-nanocarbon composite layer 16 could be a plain layer whereas the other one of the metal layer 14 and the copper-nanocarbon composite layer 16 is a mesh layer.

As also shown in FIGS. 2 and 3, a nickel interface 22 (which need only be a few nanometers thick but could also be thicker) is arranged between the metal layer 14 and the copper-nanocarbon composite layer 16. The nickel layer 22 may help to initiate electrodeposition of the copper matrix 20 into the nanocarbon tissue 18.

The proposed LSP materials benefit from the synergy of the high electrical conductivity of copper and the high ampacity of nanocarbon-based materials.

Laboratory tests were conducted with samples of the proposed LSP materials and, for comparison, with samples having a double layer of copper (without nanocarbon) on the same kind of substrate. The samples were mounted in FR4-type epoxy supports and exposed to electrical discharges of 100 kA, simulating the D wave of a lightning strike. The B and C components of a lightning strike (see FIG. 1) essentially heat up and possibly vaporize the resist on its surface, whereas a D wave causes damage to the core of composites by thermal and mechanical effects and is thus selected to study the response of materials to lightning strikes.

Vaporization of the assessed material can occur when it is struck by a D wave, depending on the electrical conductivity as well as the thickness of the material. The higher the electrical resistance of the material, (or the thinner the material), the greater will be the vaporization of the material. The area of the vaporized material as a function of its areal density (e.g., in kg/m²) may thus serve as an indicator of the efficiency of the lightning strike protection.

FIG. 3 illustrates schematically the effect of a lightning strike on an LSP material according to a preferred embodiment. After a 100 kA lightning strike, the outer of the copper-nanocarbon composite layer 16 is damaged, while the inner metal layer 14 remained intact. Specifically, a lightning strike may vaporize a portion of the copper-nanocarbon composite layer 16, forming a hole 24 therein. The bottom of the hole is formed by the metal layer 14, which implies that there was no perforation of the LSP material as a whole.

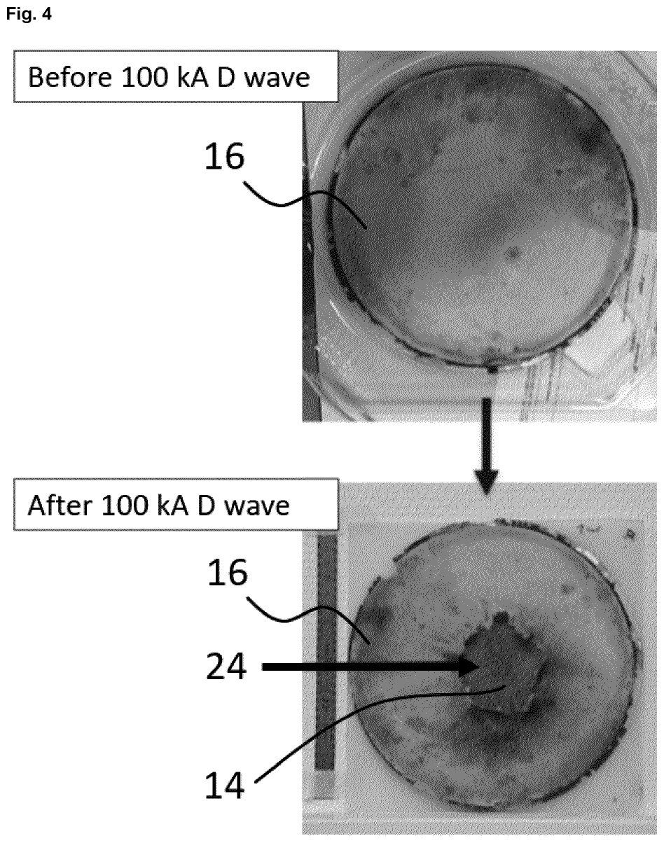

FIG. 4 shows photographs of an LSP material sample according to the disclosure before (top photograph) and after (bottom photograph) being hit by a 100 kA electrical discharge simulating the D wave of a lightning strike (in laboratory conditions). The LSP material of FIG. 4 was comprised of a substrate with a copper layer, and on the copper layer, a copper-nanocarbon composite layer.

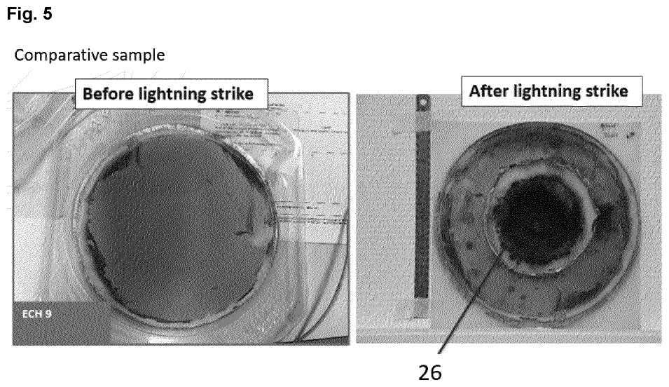

FIG. 5 shows, for comparison, photographs of a comparative before (top photograph) and after being hit by a 100 kA electrical discharge under the same conditions. The comparative sample consisted of two electroplated copper layers deposited on the same substrate as the LSP material sample of FIG. 4. It can be seen that after the application of the 100 kA lighting strike, the two copper layers are vaporized over a large diameter, leading to complete loss of lightning strike protection in the area of the attachment of the lightning channel.

The remaining electrical conductivity of the proposed LSP material after being struck by a first lightning strike could be helpful because the LSP material may still give a partial protection against further lightning strike events, and it could facilitate reparation of the damaged zone.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the disclosure, which is to be given the full breadth of the appended claims and any and all equivalents thereof.

1. A lightning strike protection material, comprising a substrate, the substrate carrying a metal layer, and, on the metal layer, a copper-nanocarbon composite layer, the copper-nanocarbon composite layer comprising a nanocarbon tangle comprised of at least one of carbon nanotubes and graphene sheets, the nanocarbon tangle being a three-dimensional cluster of the at least one of carbon nanotubes and graphene sheets in disordered arrangement embedded within a copper phase and distributed throughout the copper-nanocarbon composite layer.

2. The lightning strike protection material as claimed in claim 1, wherein the copper-nanocarbon composite layer serves as sacrificial protection layer, susceptible of being locally destroyed upon being hit by lightning.

3. The lightning strike protection material as claimed in claim 1, wherein the metal layer has a thickness in the range from 0.5 μm to 50 μm.

4. The lightning strike protection material as claimed in claim 1, wherein the copper-nanocarbon composite layer has a thickness in the range from 0.5 μm to 50 μm.

5. The lightning strike protection material as claimed in claim 1, wherein the metal layer comprises a plain layer.

6. The lightning strike protection material as claimed in claim 1, wherein the metal layer comprises a mesh layer.

7. The lightning strike protection material as claimed in claim 1, wherein the copper-nanocarbon composite layer comprises a plain layer.

8. The lightning strike protection material as claimed in claim 1, wherein the copper-nanocarbon composite layer comprises a mesh layer.

9. The lightning strike protection material as claimed in claim 1, wherein one of the metal layer and the copper-nanocarbon composite layer is a plain layer and wherein the other one of the metal layer and the copper-nanocarbon composite layer is a mesh layer.

10. The lightning strike protection material as claimed in claim 1, wherein each one of the metal layer and the copper-nanocarbon composite layer is a mesh layer.

11. The lightning strike protection material as claimed in claim 1, wherein the metal layer is or comprises a copper layer.

12. The lightning strike protection material as claimed in claim 1, wherein the metal layer is or comprises an aluminium layer.

13. The lightning strike protection material as claimed in claim 1, comprising a nickel interface between the metal layer and the copper-nanocarbon composite layer.

14. The lightning strike protection material as claimed in claim 1, wherein the copper-nanocarbon composite layer comprises at least 10% by volume of at least one of carbon nanotubes and/or graphene sheets.

15. A lightning strike protection material, comprising a substrate, the substrate carrying a metal layer, and, on the metal layer, a copper-nanocarbon composite layer, the copper-nanocarbon composite layer comprising a nanocarbon tangle formed as a three-dimensional cluster of at least one of CNTs and graphene sheets in disordered arrangement embedded within a copper phase and distributed throughout the copper-nanocarbon composite layer, wherein the copper-nanocarbon composite layer serves as sacrificial protection layer, susceptible of being locally destroyed upon being hit by lightning, wherein the metal layer has a thickness in the range from 0.5 μm to 50 μm, wherein the copper-nanocarbon composite layer has a thickness in the range from 0.5 μm to 50 μm, and wherein the copper-nanocarbon composite layer comprises at least 10% by volume of the at least one of the carbon nanotubes and the graphene sheets.

16. The lightning strike protection material as claimed in claim 15, wherein at least one of the metal layer and the copper-nanocarbon composite layer comprises a plain layer.

17. The lightning strike protection material as claimed in claim 15, wherein at least one of the metal layer and the copper-nanocarbon composite layer comprises a mesh layer.

18. The lightning strike protection material as claimed in claim 15, wherein one of the metal layer and the copper-nanocarbon composite layer is a plain layer and wherein the other one of the metal layer and the copper-nanocarbon composite layer is a mesh layer.

19. The lightning strike protection material as claimed in claim 15, wherein each one of the metal layer and the copper-nanocarbon composite layer is a mesh layer.

20. The lightning strike protection material as claimed in claim 15, comprising a nickel interface between the metal layer and the copper-nanocarbon composite layer.
